(19) United States
(12) Patent Application Publication
(10) Pub. No.: US 2015/0115607 A1
(43) Pub. Date: Apr. 30, 2015

(54) Method of increasing of sensitivity and productivity of the wind generator with vertical axis at weak winds and device for his realization

(71) Applicant: Lev Stepanov, West Orange, NJ (US)

(72) Inventor: Lev Stepanov, West Orange, NJ (US)

(21) Appl. No.: 14/064,154

(22) Filed: Oct. 27, 2013

(51) Int. Cl. F03D 7/06; F03D 3/06; H02P 9/06; F03D 9/00

(52) U.S. Cl. CPC F03D 7/06; F03D 9/002; F03D 3/067; H02P 9/06; H02P 2101/15
USPC 290/44; 415/1; 415/4.2; 415/13

(57) ABSTRACT

A Method that consists of changing power of the payload and moment of resistance on the shaft of the wind generator in proportion to current wind speeds, and reduce speed of an air flow at meeting with blades of the wind engine of proportionally angular speed of a rotor.

Wind generator for realization of the above Method contains blades formed by crossing of sectors of cavity cylinders under sharp corners to a direction of an air flow, and the depth of a cavity formed by crossing of sectors, exceeds distance between their forward borders, the internal surface of a cavity is executed with high frictional properties, and the outside surface of blades is executed with the minimal frictional properties.

Wind generator for realization of the above Method must contain at least two electric generators, mechanical transmission and an automatic control system. Electric generators can be used from automobile industry.

U.S. Patent Documents

| | | |
|---|---|---|
| 25245081 | Aug. 18, 1977 | Pohl; Lothar L. |
| Wind-turbines | | (Toronto, Ontario, CA) |
| 6,942,454 | Sep. 13, 2005 | Ohlmann; Hans-Armin |
| Vertical axis wind turbine | | (Ayr Ontario, CA) |
| U.S. Pat. No. 7,303,369 B2 | Oct. 31 , 2005 | James A. Rowan, |
| Magnetic vertical axis wind | | Thomas J. Priest-Brown |
| turbine | | |

Foreign Patent Documents

| | | |
|---|---|---|
| 8,019,887 | 1980 | FR |
| 3,505,460 | 1986 | DE |
| 2044157 | Jul. 31, 1992 | RU |
| 2087744 | Aug. 25, 1995 | RU |

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BRIEF BACKGROUND OF THE INVENTION

1. Field of the Invention

The present invention concerns wind generators with a vertical axis and can be used for development of the electric power at weak winds, characteristic for the majority of regions of moving (residing) of the man.

2. Prior Art

Now it is considered, that the wind generators with a horizontal axis of rotation have greatest operating ratio of a wind power ξ (or Cp), estimating a degree of power perfection of the wind engine and showing, what share of energy of a wind flow will be transformed to mechanical energy.

For wind generators with a horizontal axis theoretically he can reach ξ=0.593.

From wind generators with a vertical axis the rotor the wind generator Savonius with a floor by cylindrical blades is most known which has ξ equal 0.18.

Other wind generators, among which greatest are known also ξ, equal 0.35 (on other data up to 0.42) has a rotor Bolotov. <<Cost of the smallest complex Bolotov by capacity from 1 kw makes about 3 thousand dollars>>.

Primary distribution has received propeller wind generators, at which the axis of a wind wheel is horizontal and is parallel a direction of a flow. They have best ξ up to 0.48 also are more reliable.

### BRIEF SUMMARY OF THE INVENTION

The basic lack of known wind generators is the low productivity of the electric power in zones with average annual speed of a wind below 8 m/s, that essentially reduces demand of the mass consumer, which lives at regions, where the average annual speed of a wind is within the limits of 4-6 m/s and seldom exceeds 7-8 m/s.

The disadvantage of such wind generators is the application of special multi-pole electrical generators, which can not to develop nominal electrical capacity at rather small speeds of rotation and insufficient mechanical capacity of a rotor. Their design it turns out bulky and heavy, in electrical generators the expensive magnetic alloys are applied.

Volume of manufacture of small wind generators by capacity up to 5 kW is estimated in several tens, is rare in hundreds copies, that does not allow to organize their serial, and, especially, mass manufacture and to lower a sale price to a level accessible to the mass consumer.

At the time of writing of this application all over the world, there were about 35,000 wind turbines rated up to 5 kW.

On the data of the Department of Energy (DoE) of USA the need of a home market of USA is estimated in 15-16 millions wind generators for the individual users and small enterprises.

The purpose of the present invention is the exception of the specified lacks and maintenance of high efficiency of the electric power at average annual speeds of a wind 4-6 m/s, characteristic for the majority of regions of a planet, and also maintenance of low cost of wind power generators and their availability to the mass consumer at high profitability for the manufacturer.

### DESCRIPTION OF THE DRAWINGS

FIG. 1—general view of the wind generator with a vertical axce;

FIG. 2—pair of blades of a rotor as crossing sectors cavity of cylinders;

FIG. 3—cross section of a rotor with three blades;

FIG. 4—increased image of a ground part of the wind generator;

FIG. 5—plan a belt of transfer and electrogenerators;

FIG. 6—mechanical transmission;

FIG. 7—planetary gear transfer mounted in a small pulley a belt of transfer;

FIG. 8—circuit a belt of transfer with a press controlled roller in an initial rule(situation);

FIG. 9—circuit a belt of transfer with a press controlled roller in a working rule(situation);

FIG. 10—diagram of capacity and angular speed of a rotor;

FIG. 11—diagram of change of force of frontal resistance F section for half of revolution of a rotor;

FIG. 12—diagram of aerodynamic force working on section of a rotor.

By positions on figures are designated:
1—blade;
2—section of a rotor;
3—drive shaft;
4—large pulley;
5—small pulley-planetary carrier;
6—electrogenerator;
7—belt;
8—basis frame;
9—concrete base;
10—top unit of bearings;
11—bottom unit of bearings;
12—clutch muff;
13—insert;
14—motionless wheel of planetary transfer;
15—central wheel of planetary transfer;
16—satellite planetary gear;
17—the case of the planetary gear;
18—overlay;
19—axis of the satellite;
20—ball-bearing;
21—rack;
22—clutch;
23—pressure roller;
24—lever,
25—constant magnet;
26—magnet-sensitive contact
27—electronic control unit;
28—electromechanical drive.

The dashed lines with pointers on figures show a direction of movement of a flow of air at meeting with surfaces of blades of a rotor.

The continuous lines with pointers show a direction of rotation of a rotor.

By the letters on figures are designated:
V˜—speed of a wind;
ω—angular speed of a rotor;
R cp—radius of the centre of pressure of blades of a rotor;
D rot—diameter of a rotor;
L—depth of a cavity;
h1, h2—chord of sectors to a floor of cylinders;
β—corner of displacement between adjacent on height by sectors of blades of a rotor;
f—frictional zones of cavities of blades.

### BACKGROUND OF THE INVENTION

Of aerodynamics known that the drag coefficient Cx has three components: Cx pressure, Cx friction and Cx inductance.

Cx=Cx pressure+Cx friction+Cx induction

The shape of the profile determines pressure resistance. Frictional resistance depends on the roughness of the streamlined surfaces. The inductive reactance is shown at supersonic speeds and wind energy is not considered.

Aerodynamic drag coefficient Cx for a flat plate is Cx=1.0, for a parachute Cx≈1.2, for a hollow half-cylinder and a hemisphere Cx≈1.4 blowing in from the cavity, while blowing the convex side Cx≈0.9. For bodies of revolution ogival form of the coefficient Cx can be 0.3 when blowing from the pointed top.

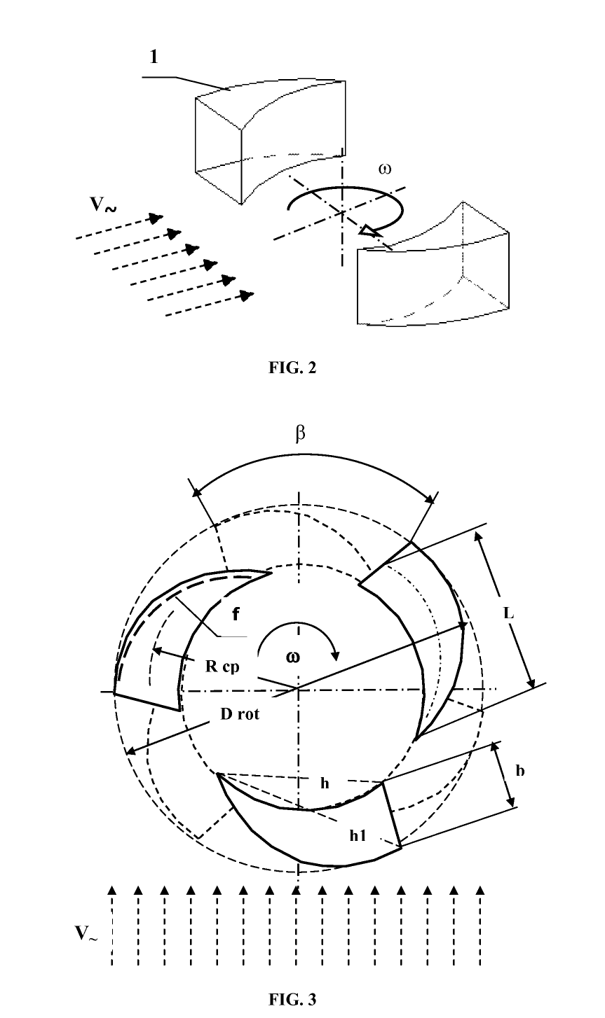

A couple of the blades shown in FIG. 2, the rotary aerodynamic torque:

M=ΔF·R cp.

wherein:

R cp—distance from the rotational axis of the rotor blade to the center of pressure;

ΔF—the resultant aerodynamic force acting on the rotor blades.

On the left (lead) rotor blade aerodynamic force acts:

F_{left}=Cx·ρ·V_{˜}²/2

accepts that the blade moves with a velocity of flow. On the right (inhibiting) effect of rotor blade aerodynamic force

F_{right}=Cx·ρ·(2V_{˜})²/2,

because the blade is moving against the flow of air and the local velocity of flow of the meeting with a blade doubles. The actual tip speed of the blades is less than two interrelated flow velocity, because the system operates the braking force of the payload (the generator, the friction in the bearings) plus the aerodynamic resistance of the right blade.

In theory, the wind turbine uses the concept of the braking rate of the rotor

e=v1/V,

where v1—the rate of deceleration of flow at the wall of the working fluid, in this case, the rotor blades.

In view of the foregoing expression of the aerodynamic force acting on the left leading blade of the rotor takes the form:

F_{left}=Cx·ρ·(V_{˜}−v1)²/2,

and for the right braking blade:

F_{right}=Cx·ρ·(V_{˜}+v1)²/2.

The resultant moment of the aerodynamic forces acting on the right and left rotor blade takes the form:

ΣM=ΔF· [symbol] =(F_{left}−F_{right})·R_{cp}=(Cx1·ρ·(V_{˜}−v1)²/2−Cx2·ρ·(V_{˜}−v1)²/2)·R_{cp}

where:

Cx1—an aerodynamic drag coefficient of the left hollow blades;
Cx2—aerodynamic drag coefficient of the right lobe.
Substituting the values of Cx for a hollow half-cylinder, above, to get the Savonius:

ΣM=(1.4ρ·(V_{˜}−v1)²/2−0.9 ρ·(V_{˜}+v1)²/2)·R_{cp},

For the rotor blades shown in FIG. 2 Cx1 value can be expected more than 1.4, and Cx2 amount—less than 0.5. This suggests a higher efficiency of the proposed form of blades.

Taking into account that the magnitude of the aerodynamic coefficients depends on the roughness of the surfaces of the blades interacting with the air stream to minimize the power loss of aerodynamic outer surface of the rotor blades is made with a minimum roughness and internal—the maximum (area f in FIG. 3).

In this case, the expression for the aerodynamic torque acting on the rotor becomes:

ΣM=ΔF·R_{cp}=((1+η₁)·F_{left}−(1−η₂)·F_{right})·R_{cp},

wherein:

η₁—coefficient friction inner surface of the blade,
η₂—coefficient of friction of the outer surface of the blade

Rotor power is given by:

Nᵣₒₜ=ΣM·ω

where ω—angular speed of the rotor.

For engineering calculations power vertical rotor adopted the expression used for propeller turbines:

Nᵣₒₜ=3.85·10⁻³·ρ·Dᵣₒₜ²·V³·ξ,

where:

Nᵣₒₜ—the rotor shaft power, kW;

ρ—density of the air;

V—velocity of the wind;

D rot—the diameter of the rotor;

ξ—coefficient utilization of wind energy.

For a vertical rotor in the formula has the equivalent diameter of the propeller:

Dₚᵣₒₚₑₗ=(4·S/π)^{0.5}

where: S—sectional area of the rotor, through which the incoming air stream:

S=(Dᵣₒₜ·hᵣₒₜ)/2

In determining the power of the rotor is made only area left by FIG. 2 leading blade of the rotor through which the incoming flow causes the rotor to rotate, but not the entire area circle of wings through which the ram air, as is customary for propeller turbines with a horizontal axis of rotation.

The influence of right-blade rotor is taken into account braking coefficient e=v1/V. Frontal pressure on the rotor is given by:

P_{front}=B·ρ·V_{˜}²·S/g,

where:

g=9.81 m/s2—acceleration due to gravity (Hereinafter all dimensions are given in the international system of units).

B—frontal pressure ratio (see Table 1.)

The angular speed of the rotor is given by:

ω=V˜·R cp·e,

where:

R cp—the radius of rotation of the center of pressure of the blade averaged over one rotation around the axis of the rotor *) *) Wind turbine project is designed primarily for individual users who live in separate houses.

e—braking rate of air flow on the blade surface (see Table 1).

Odds and e and ξ asked coefficient calculated from the deceleration of the rotor shaft, in table 1, which are the utilization of wind power and frontal pressure ξ and B, depending on the drag coefficient e=v1/V.

TABLE 1

| | | | | | | | | | | | |
|---|---|---|---|---|---|---|---|---|---|---|---|
| e | 0 | 0.1 | 0.2 | 0.3 | 0.4 | 0.5 | 0.6 | 0.7 | 0.8 | 0.9 | 1 |
| ξ | 0 | 0.23 | 0.48 | 0.58 | 0.576 | 0.5 | 0.384 | 0.252 | 0.128 | 0.036 | 0 |
| B | 0 | 0.28 | 0.62 | 0.83 | 0.96 | 1.0 | 0.96 | 0.84 | 0.64 | 0.37 | 0 |

Apart from the ways of increasing the aerodynamic torque acting on the rotor, the invention provides for the possibility of increasing the momentum of the aerodynamic force by increasing the exposure time of this force on the leading blade of the left:

The greater the depth of the cavity L on FIG. 3 and the longer the path traversed by the air flow within the cavity, the longer exposure time of the rotor flux. Since the cavity is a semi-enclosed space, the flow reaches the bottom of the cavity and the impact on the blade for the time until the blade is out of range of the flow and do not go away in the shadow of neighboring blades. In this way, the kinetic energy of the rotor flux transmitted more fully.

For a rotor consisting of blades n, the exposure time for one flow blade is defined as follows:

The length of the circle described by the center of pressure of the blade: S_{circle}=2π. R cp;

Exposure time flow on the rotor for one complete revolution: tᵣₒₜ=S_{circle}/V˜;

Exposure time flow on one blade:: tₜ≈tᵣₒₜ/n.

During this time, the rotor is rotated by an angle α=360°/n. The proposed format for the rotor is now more dependent on the depth of the cavity L, rather than on the number of blades n.

In this case it is determined by the relation:

t₁=tᵣₒₜ·L/S_{circle}=tᵣₒₜ·L/(2π·R cp).

Impulse aerodynamic force acting on the leading blade from hitting the oncoming flow since the target blade until the blade out of the flow is determined by the expression:

I=F_{average}·tᵣₒₜ=Cx·ρ(V_{˜}−v1)²/2·S_{M}·tᵣₒₜ/n.

The value of the aerodynamic force F_{average} during rotation ranges from zero when entering the inlet section of the blade in the flow to a maximum at a position where the inlet section of the blade perpendicular to the flow, and decreases to zero at the moment of the inlet section of the blade thread.

For the calculations made:

F_{average}=F_{left}/2.

Based on the technique described algorithm aerodynamic calculations, part of a complete mathematical model of a vertical axis wind turbine blades and aerodynamic shape of the present invention.

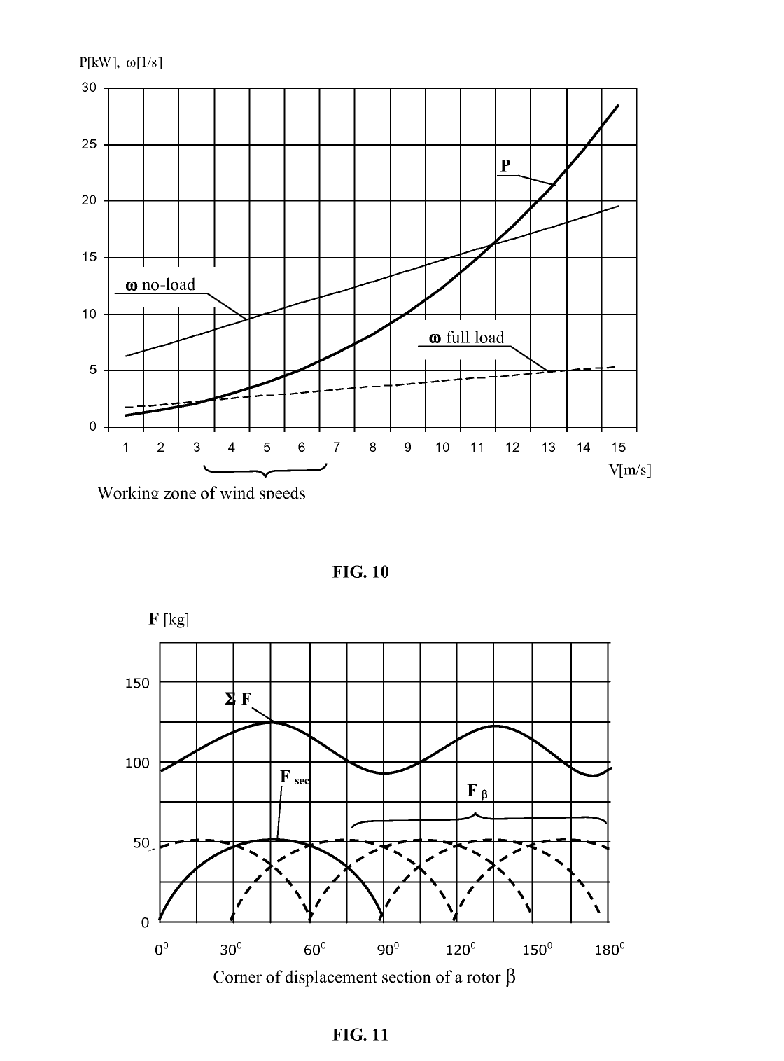

At FIG. 10 shows diagrams of power and angular velocity of the rotor at idle and full load obtained by said mathematical model.

As a result of numerical studies of the mathematical model is established that the main criterion of excellence of the proposed wind turbine—the utilization of wind energy is ξ=0.318÷0.5 and can be brought to more than 0.576, and by the frictional inner surface of the blade and the optimal ratio of its geometric parameters—the width of the inlet and the depth of the cavity.

Another factor influencing the sensitivity of the rotor mathematical models and graphical-analytical method determined that the optimal number of rotor blades n=3 . . . 5. For a large number n neighboring blades will shade each other, the depth of the cavity will decrease and the momentum integral aerodynamic force will decline.

In summary, we can say that the shape of the blades shown in FIG. 2 and FIG. 3, provides the highest possible sensitivity of the rotor in light winds. The angular velocity of the rotor depends mainly on the moment of resistance generated by the payload, which illustrates the relationship ω no-load and ω full load, represented in FIG. 10.

To the weak wind and the uniformity of the rotation of the rotor blades is split into sections for height and angular displacement of adjacent sections at an angle β, as shown in FIG. 3.

At FIG. 11 is a diagram of the ram pressure force Fsec, acting on the leading edge of the section during its rotation around the vertical axis of the rotor from the moment of entry into the incoming air stream to the exit of the incident flow. The dotted line shows the diagram of forces F_{β} section adjacent the height of the rotor sections being offset angle β. The solid line shows the total aerodynamic force ΣF, rotating rotor.

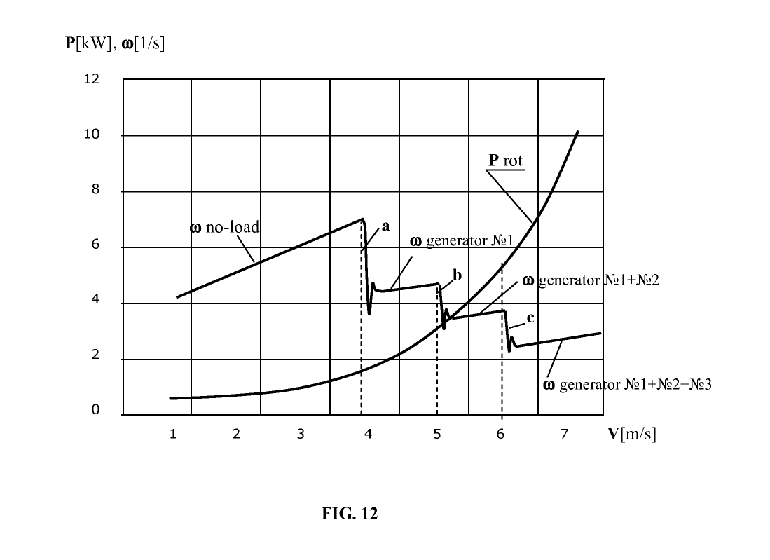

At FIG. 12 is a graph of power and rotor speed generators connected to the rotor at a predetermined wind speed range, the values of which are defined by said mathematical model. The calculation was performed for the wind turbine for the individual user.

Dimensions of the wind turbine—the height of 10 meters and a rotor diameter of 1.8 meters. The apparatus used in typical automotive generators, developing electric power ˜700 volt-amperes at speed ˜1500 rpm. The number of power generators 3.

The first generator is connected to the rotor of the wind turbine at wind speeds ˜4 m/s.

At this speed the rotor produces mechanical power ˜1.6 kW electric generator is sufficient to bring into rotation based on a mechanical transmission losses.

Second generator connected to the windmill rotor when the wind speed ˜5 m/s.

At this speed, the rotor develops a mechanical power of ˜3.2 kW, sufficient to rotate the two automobile generators with total electric power 1400 volt-amperes.

The third generator is connected to the rotor of the wind turbine at wind speed of ˜6 m/s. At this speed, the wind rotor develops a mechanical power of ˜5.0 kW, sufficient to rotate the three motor generators with total capacity of 2.100 volt-amperes.

It is noted that an electric power of 1 kW˜working continuously at a wind speed of 5-6 m/s generates more electricity than 5 kW generator operated at wind speed ˜10 m/s during the season winds (˜30 days).

The required speed electric generators in the selected range of wind speeds achieved by mechanical transmission.

The number of generators can be increased and the nominal electric power wind turbine would increase accordingly. However, this is achieved by increasing the threshold wind speed above the average annual values of 7-8 m/s.

Numerical study of mathematical models have shown that the full energy by living in a detached house, you need an average of 500-700 kW hours of electricity per month, and it is provided with continuous work wind turbine with an average wind speed of 6 m/s.

This is enough electricity consumption for lighting, heating, electric stove, refrigerator, air conditioner and other household appliances.

The diagram on FIG. 12 gives a simplified representation of the physical nature of the invention and the process of its operation when connecting generators to the drive shaft of the rotor.

The present invention is a self-adjusting electromechanical system with feedback. In this system, when connecting generators transients occur. These transients are illustrated by curves a, b and c, connecting straight sections diagrams angular speed of the rotor at steady speeds. In the mathematical model adopted by a fixed value of the coefficient of wind energy ξ. In fact ξ coefficient is variable, which depends on the combination of the current values of a number of physical factors operating in a given time.

Studies of mathematical models show that with the connection of each following an electric coefficient ξ and effectiveness of the product as a whole increased.

Due to the lack of experimental data in the application are the minimum design parameters of the proposed technical solutions.

### DETAILED DESCRIPTION

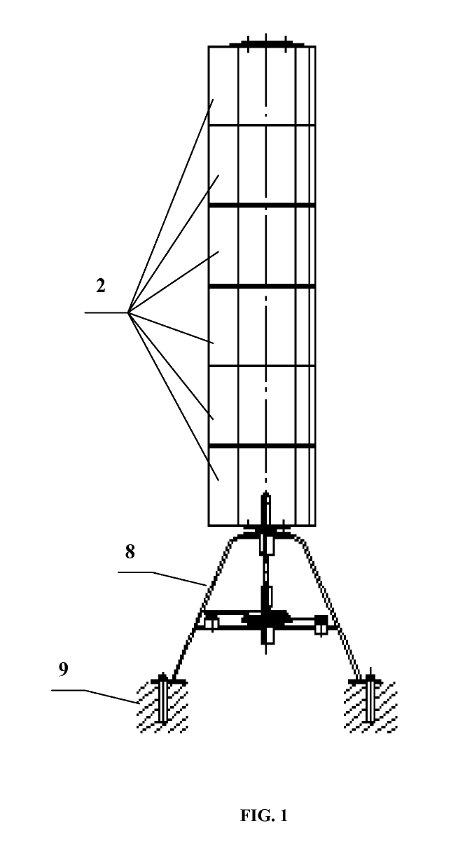

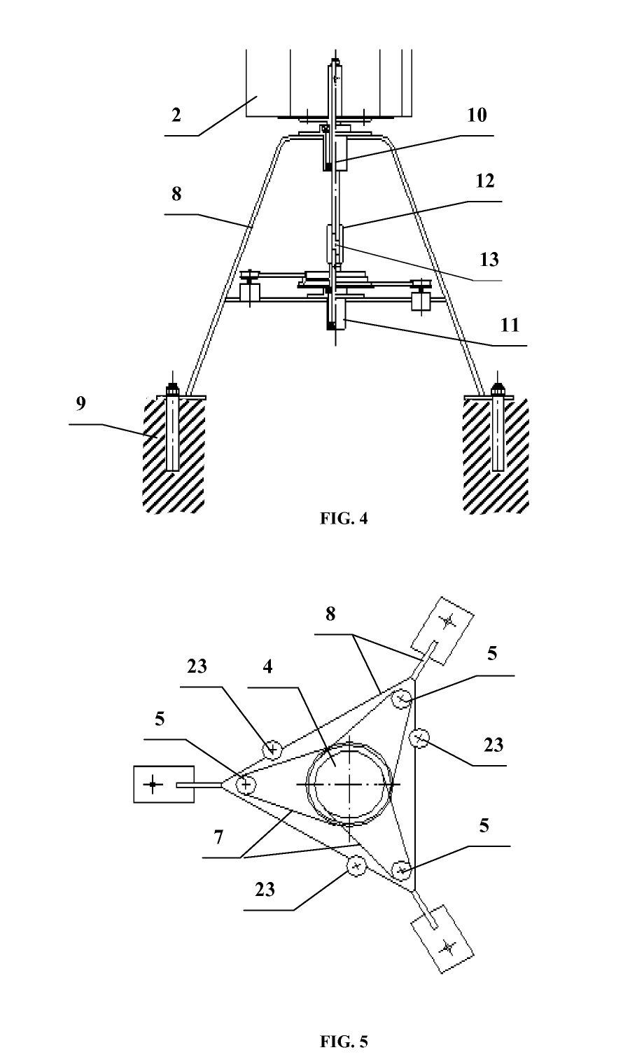

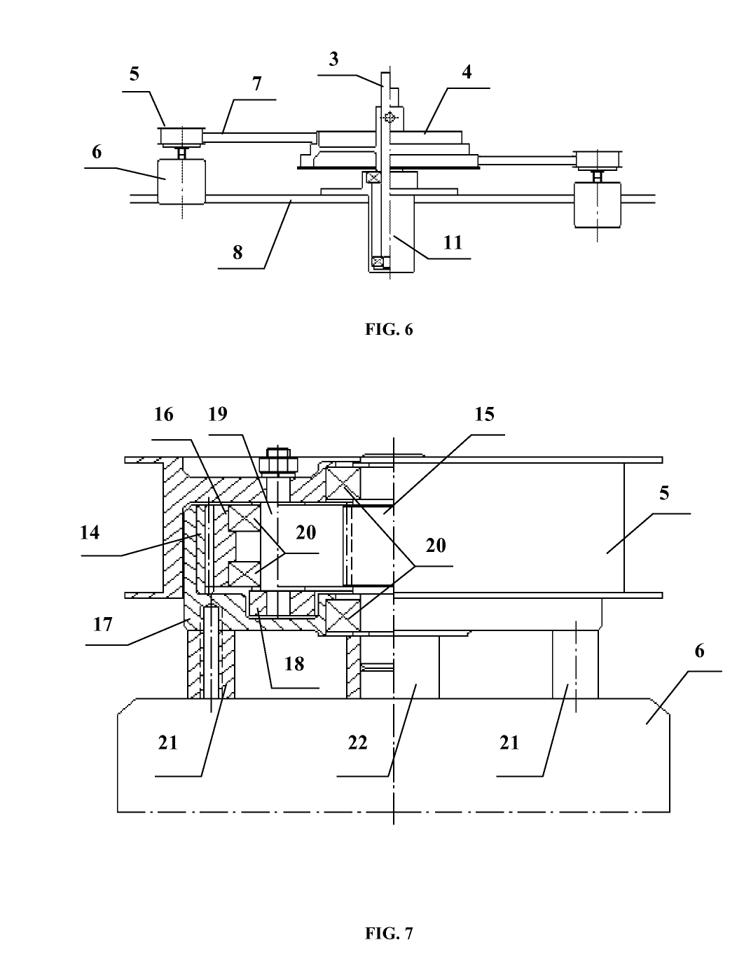

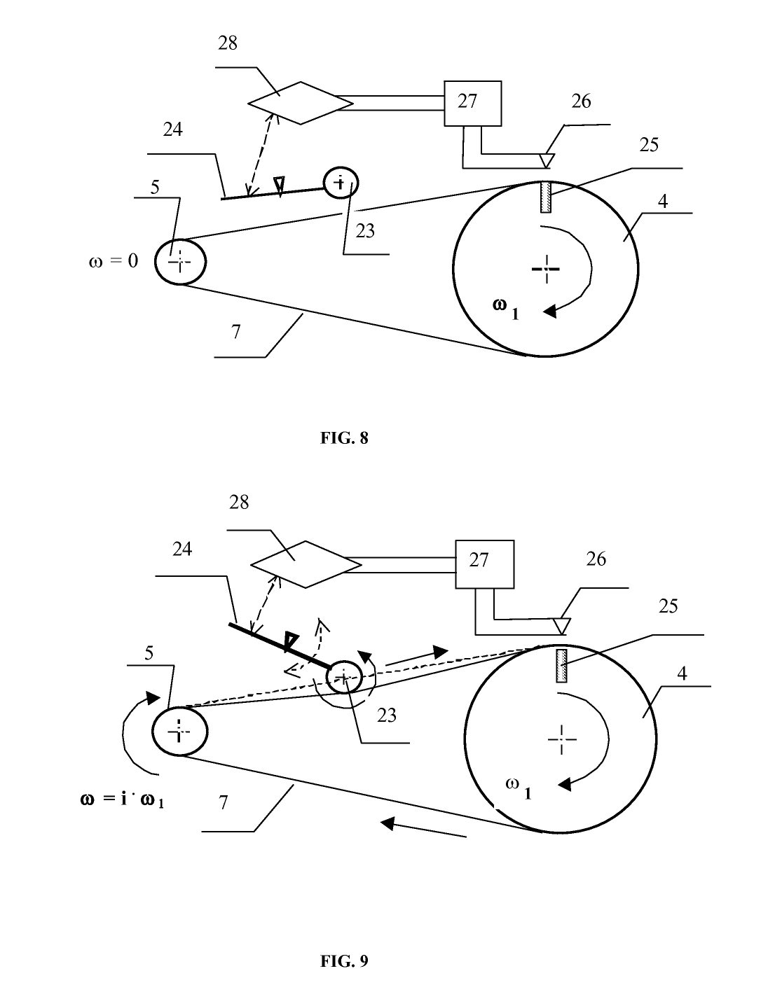

The design of the wind turbine, shown in the figures FIG. 1, FIG. 4, FIG. 5, FIG. 6 and FIG. 7 is simple and requires no special explanation. It consists of nodes: a support frame, sections of the rotor, a belt transmission, electric generators, and pinch rollers.

The basis frame 8 comprises an top unit of bearings 10 and bottom unit of bearings 11, which is installed in the drive shaft 3, divided into upper and lower parts connected by a clutch muff 12 and the insert 13 for ease of assembly and routine maintenance—changing worn belts 7. The service life of flat cotton belt is ˜1500-2000 hours. In continuous operation—is 60-80 days. When using a rubber-belt life increased to 2500 hours or 100 days. Belt 7 of uniform thickness, width and length.

The basis frame 8 is installed on a concrete base 9. Elements of the basis frame made of standard metal profiles, joined together by welding.

Upper and lower bearing assemblies 10 and 11 are made of steel or aluminum alloys hot forging and subsequent mechanical machining.

Drive shaft 3, the clutch muff 12 and insert 13 are made of steel round rod. Large pulley 4 is formed by injection molding of aluminum alloy and subsequent machining. The use of heavier steel construction and increases the axial moment of inertia of the large pulley 4, which reduces the sensitivity of the wind turbine for low wind speeds.

Small pulley—planetary carrier 5 is made of a round steel rod by stamping and subsequent mechanical machining.

Large pulley 4 is mounted on the drive shaft 3 by press fitting or any other method of providing torque transmission.

Ball-bearings 20 bearing assemblies 10 and 11—the standard radial and angular contact, unified by the basic dimensions.

Sectors 2 of the rotor mounted on top of the drive shaft 3. Sectors can be made of aluminum alloy sheet by bending, and TIG welding. The variant of the manufacture of plastic.

Wheels 14 and 15 as well as the satellites of the planetary gear 16 are made of steel by mechanical processing.

The case of the planetary gear 17 and overlay 18 made of structural steel by stamping and subsequent machining.

Motionless wheel of planetary transfer 14 is installed in the case of planetary transfer 17 on the press-fit.

Satellites 16 are mounted in ball-bearings 20 on axles 19 between the central wheel 15 and the—motionless wheel 14 of the planetary gear.

Axles 19 are secured to the ends of the small pulley—planetary carrier 5 and the overlay 18.

Collected planetary gears mounted on the housing electrical generator 6 via racks 21. Shaft generator 6 connected to the central wheel of the planetary gear 15 by the clutch 22.

When used as an electric generator 6 automobile generator with the horizontal axis of the necessary improvements to the housing mounting racks 21 and replacing the lower bearing on the angular contact ball-bearing.

Pressure roller 23 is mounted on the lever 24 of the electromechanical drive 28 and may be mounted on the basis frame 8 or on the housing the electrogenerator 6. In the latter case housing of the generator 6 must have corresponding seats.

The electronic controller 27 mounted on the basis frame 8 near the large pulley 4, so that the magneto-sensitive contact 26 is located in the plane of rotation of the large pulley 4 has a gap with constant magnet 25. An analogue electronic control unit 27 can serve as a centrifugal regulator sequentially closing electrical contacts 26 when it reaches a predetermined speed.

The device described operates as follows:

When the speed of wind below the threshold of sensitivity rotor is of the wind turbine is stationary. When exceeding threshold sensitivity rotor starts rotate together with shaft 3 and large pulley 4, however on generators 6 rotation not transmitted as belts 7 does not into engagement with a small pulley—planetary carrier 5.

When the constant magnet 25 passes near the normally open contacts 26 are magnetically short-circuit them and electric pulse is applied to the electronic control unit 27 which compares the measured frequency with a predetermined pulse frequency programmed in accordance with the expected wind speed.

When the operating wind speed of 4 m/s and measured by the coincidence of the reference frequency pulses and the electronic control unit 27 generates a command signal to the electromechanical drive 28.

Electromechanical drive 28 rotates the lever 24. Pressure roller 23 for the belt 7 introduces it into engagement with the small pulley—planetary carrier 5.

Satellites 16 associated with small pulley—planetary carrier 5 meshed with the motionless wheel of the planetary gear 14 to transmit the rotation of the central wheel 15 and through a coupling 22 to the generator 6, which provides it with the desired speed.

Electric generator 6 begins to produce an electric current flowing to the battery terminals.

When the wind speed of 5 m/s in the same manner the following is an electric connection, the process is repeated and the power is doubled. With an increase in wind speed of 6 m/s the process is repeated, connects the third power generator and electric power tripled.

Changing the angular velocity of the rotor, this occurs when connecting generators, shown in FIG. 12.

When the wind speed decreases, the process proceeds in the reverse order and generators 6 disconnected from the drive shaft 3.

As already mentioned, for the implementation of this construction and the choice of the design parameters of the rotor and the other component units described wind turbine with a vertical axis, a mathematical model, which is a multi-parameter function, which includes:
Methods of designing wind turbine components,
A description of the physical processes occurring in the operation of these units,
The necessary database;
Technical and economic assessment of the technical solutions,
The search for methods of linear algebra, the global maximum of a multi-parameter function, which ensures compliance with the main criterion—the “minimum cost—maximum performance.”
The techniques are built using existing computer programs;
The mathematical model is interactive and in addition to an optimal ratio between the parameters of structural elements allows for the rapid analysis of existing technical solutions and trends appearing in the field of wind energy.

The results of the analysis of the technical solutions of wind turbines vertical and horizontal models, published on the Internet at the time of registration of the present application, lead to the conclusion that the proposed technical solution on the parameters exceeds the known technical solutions.

An example embodiment of the invention may serve a vertical axis wind turbine having the following design parameters obtained by said mathematical model:
Rotor diameter 1.8 m*);
Height of the rotor sections 8 m*);
The height of the base 2 m;
Mass of the rotating parts of ˜270 kg*);
The working range of wind speed 3.9-6.4 m/s;
Sensitivity is 2.6 m/s;
Maximum design wind speed of 16 m/s;
Rotational speed of 34-138 RPM;
Level of made noise ˜0 decibels *);
Total electric power—2.1 kW;
Power generators—asynchronous, automobile;
Productivity at an average annual wind speed of 6.0 m/s (247 days per year)−500 kWh/month, which is enough to supply power to the rural house (lighting, heating, electric stove, refrigerator, air conditioning and other appliances);
The cost of 1 kilowatt of power ˜600 dollars;
Fair value of the wind turbine manufacturer in the rate of return of 100% and the volume serial production of 10,000 pcs/year—1270 dollars;
With a minimum salary of 7.25 $/hour and the volume of production and sales of 100 thousand units/year can be created 3,000 jobs, manufacturing wind turbines may be the automotive industry;
The payback period for the consumer (if the price of electricity, operating in the United States, Russia and Europe)—1.6 . . . 2.5 years.

Dimensions, weight and the level of noise produced by a wind generator can set in within 10 meters of a dwelling house, or on the roof of the house, and the support frame to the transmission, power generators and other electrical equipment may be placed under the roof of the attic.

Characteristics of the wind turbine (wind speed operating range, power consumption and performance) can be adapted for specific weather conditions and needs of the consumer.

The area of the proposed technical solutions can be expanded, for example, for power supply substations pumping oil and gas pipelines, or other objects with the need for independent power supply.

1. A method increasing of sensitivity and productivity of wind generator with a vertical axis that consists of changing power of the payload and moment of resistance on the shaft of the wind power generator in proportion to current wind speeds, and reduce speed of an air flow at meeting with blades of the wind engine of proportionally angular speed of a rotor.

2. A wind generator with a vertical axis for realization of the above method of claim 1 contains blades formed by crossing of sectors of cavity cylinders under sharp corners to a direction of an air flow, the depth of a cavity formed by crossing of sectors, exceeds distance between their forward border, the internal surface of blades is executed with high frictional properties (roughness), and their outside surface is executed with the minimal frictional properties (grinding).

3. A wind generator with vertical axis for realization of the above method of claim 1 must contain at least two electric generators, mechanical transmission and an automatic control system, electric generators and other electric equipment can be used from automobile industry.

4. A the mechanical transmission wind generator of claim 3 is executed a belt transfers, which large pulleys are established on the drive shaft of a rotor, and the small pulleys are established on shaft of electrical generators, which can contain planetary gear transfer established between a rotor and electrical generators, thus the transfer numbers of each transfer are established from a condition of maintenance of rated power and speed of rotation of electrical generators at achievement of the given speeds of a wind.

5. A belt transmission of claim 4 are supplied with press rollers and electromechanical drives connected to system of automatic control, the system of automatic control contains the sensor of speed of a wind, circuit of comparison of the programmed and current size of speed of a wind and formation command signal, the sensor of speed of a wind can be executed as constant magnets mounted on the drive shaft of a rotor, and magnet of sensitive contacts located in a plane of rotation of constant magnets.

6. A blades to claim 2, divided by height in sections, which are deployed around the rotor axis by an angle equal to the quotient of 360 degrees by the number of sections of the rotor.
